(19) United States
(12) Patent Application Publication
(10) Pub. No.: US 2015/0312711 A1
(43) Pub. Date: Oct. 29, 2015

(54) SYSTEM AND METHOD FOR RECORDING DATA OF VISITS ON WIRELESS COMMUNICATION DEVICE

(71) Applicant: 2GATHER INC., Seodaemun-gu Seoul (KR)

(72) Inventors: Sang Jun PARK, Seoul (KR); Yeong Woong PARK, Seoul (KR); Sung Ho PARK, Seoul (KR); Jun Ho CHOI, Gyeonggi-do (KR)

(73) Assignee: 2GATHER INC., Seoul (KR)

(21) Appl. No.: 14/647,029

(22) PCT Filed: Nov. 20, 2013
(86) PCT No.: PCT/KR2013/010560

§ 371 Date: May 22, 2015

(30) Foreign Application Priority Data
Nov. 23, 2012 (KR) 10-2012-0133694

(51) Int. Cl. H04W 4/02; H04W 40/24; H04W 72/04

(52) U.S. Cl. CPC H04W 4/02; H04W 72/0406; H04W 40/246; H04W 88/02

(57) ABSTRACT

Provided is a method and system for ensuring that a service user has actually visited a service providing store. According to an embodiment, there is provided a system for recording visit data of a wireless communication device. The system includes: an electronic device which includes one or more sensors that can recognize locations and motions; the wireless communication device which includes one or more sensors that can recognize locations and motions; and a server which transmits to the wireless communication device data indicating that the wireless communication device has visited a location where the electronic device is installed if it is sensed by the sensors of the electronic device and the sensors of the wireless communication device that the electronic device and the wireless communication device exist within a predetermined distance range and that predetermined motion conditions have been executed.

### RELATED APPLICATIONS

This patent application claims the benefit under 35 U.S.C. §371 of International Application Number PCT/KR2013/010560, filed Nov. 20, 2013, which claims priority to Korean Patent Application No. 10-2012-0133694, filed Nov. 23, 2012, both of which are incorporated herein by reference.

### TECHNICAL FIELD

The present invention relates to a system and method for recording visit data of a wireless communication device, and more particularly, to a system and method for recording visit data in a wireless communication device of a user when the user visits a particular place.

### BACKGROUND ART

In general, when a service user visits a service providing store such as a restaurant or a café, he or she presents a reward coupon issued offline or online to accumulate mileage or receive a benefit such as an additional service based on the accumulated number of visits.

According to this method, however, since the service user has to carry a reward coupon for each restaurant or café, it is very cumbersome. In addition, if the service user does not have a reward coupon when visiting a service providing store, his or her visit to the service providing store cannot be counted.

To solve these problems, various methods using smartphones that are being rapidly widespread are gradually being popularized to replace reward coupons. For example, a quick response (QR) code may be provided at a store, and a service user may capture the QR code using his or her smartphone. Accordingly, the service user's visit to the store (such as a restaurant or a café) may be recorded in a server.

However, the problem with this method is that the service user can capture a QR code provided at a store and then falsely verify his or her visits to other restaurants or cafés using the captured QR code as if he or she actually visited these places.

To solve this problem, a method of identifying whether a service user has actually visited a store using global positioning system (GPS) information has been disclosed. However, this method still has a problem in that a service user located near a store within an error range of the GPS information can falsely verify his or her visit to the store as if he or she actually visited the store.

A service user cannot only falsely verify his or her visit to a service providing store or a service provider without actually visiting the service providing store or the service provider but also evaluate the service of the service providing store or the service provider.

In addition, since mileage (points, stamps, etc.) can be accumulated on a coupon for each service providing store (such as a coffee shop, a hair salon, etc.), there is no way to accumulate mileage on a coupon for each service provider (such as a barista, a hair stylist, etc.) who actually provides a service and to evaluate the service of each service provider.

Patent Literature 1 (Korean Patent Publication No. 10-2004-0063420) discloses a method of providing accumulated points using a mobile barcode. The method includes displaying a barcode on the screen of a terminal (operation S101), scanning the displayed barcode (operation S102), converting the scanned barcode into processable data (operation S103), generating billing data including the processable barcode data and a billing amount and transmitting the billing data to a main server (operation S104), checking whether or not a registered member and the billing amount by analyzing the billing data received by the main server (operation S105), paying the billing amount and calculating earned points according to the paid amount (operation S106), accumulating the earned points (operation S107), and transmitting information about the completion of payment and information about the accumulation of the earned points to the terminal (operation S108).

In the above method, a barcode is displayed on the screen of the terminal and then scanned to replace the role of a reward coupon.

However, Patent Literature 1 fails to offer the fun of accumulating mileage (points, stamps, etc.) by providing an actual reward coupon-like interface. In addition, the related art fails to provide the same interface as a paper coupon to general clerks and customers who are accustomed to paper coupons and to provide any other fun than accumulating points using a unique data transmission method.

### DISCLOSURE

### Technical Problem

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

It is an objective of the present invention to provide a method and system for identifying whether a service user has actually visited a service providing store.

It is another objective of the present invention to provide a method and system for rewarding a service user based on the accumulated number of uses not only for each service providing store but also for each individual service provider and evaluating the service of each individual service provider. Further, it is another objective of the present invention to ensure that a service is evaluated by a user who actually received the service.

It is another objective of the present invention to provide a method and system for identifying whether a service user has received a service from a particular service provider.

It is another objective of the present invention to provide a service user and a service provider with a new experience of accumulating mileage (pints, stamps, etc.) on a coupon through a new interface.

### Technical Solution

According to an embodiment of the present invention, there is provided a system for recording visit data of a wireless communication device. The system includes: an electronic device which includes one or more sensors that can recognize locations and motions; the wireless communication device which includes one or more sensors that can recognize locations and motions; and a server which transmits to the wireless communication device data indicating that the wireless communication device has visited a location where the electronic device is installed if it is sensed by the sensors of the electronic device and the sensors of the wireless communication device that the electronic device and the wireless communication device exist within a predetermined distance range and that predetermined motion conditions have been executed.

According to another embodiment of the present invention, there is provided a method of recording visit data of a wireless communication device. The method includes: transmitting data indicating that the wireless communication device has visited a predetermined place where an electronic device is installed from the electronic device to a server; transmitting data indicating that the wireless communication device has visited the predetermined place where the electronic device is installed from the wireless communication device to the server; and transmitting visit data indicating that the wireless communication device has visited the predetermined place to the wireless communication device.

The method may further include displaying the visit data on the wireless communication device in a predetermined pattern.

According to another embodiment of the present invention, there is provided a system for recording visit data of a wireless communication device. The system includes: the wireless communication device which includes one or more sensors that can recognize locations and motions; an electronic device which includes one or more keys for transmitting data to a server; and the server which transmits to the wireless communication device visit data indicating that the wireless communication device has visited a location where the electronic device is installed, wherein the server transmits to the wireless communication device the visit data indicating that the wireless communication device has visited the location where the electronic device is installed if the presence of the wireless communication device in the location where the electronic device is installed is sensed by the sensors included in the wireless communication device, if a predetermined key among the keys of the electronic device is pressed, and if a predetermined motion of the wireless communication device is sensed by the sensors included in the wireless communication device.

According to another embodiment of the present invention, there is provided a system for recording visit data of a wireless communication device. The system includes: the wireless communication device which includes one or more keys for transmitting data to a server; an electronic device which includes one or more keys for transmitting data to the server; and the server which transmits to the wireless communication device visit data indicating that the wireless communication device has visited a location where the electronic device is installed, wherein the server transmits to the wireless communication device the visit data indicating that the wireless communication device has visited the location where the electronic device is installed if the presence of the wireless communication device in the location where the electronic device is installed is sensed by a position sensor of the wireless communication device, if a predetermined key among the keys of the electronic device is pressed, and if a predetermined key among the keys of the wireless communication device is pressed.

According to another embodiment of the present invention, there is provided a data transmission device connected to a server so as to transmit visit data to a wireless communication device. The data transmission device includes: a handle part which is made of a conductive material; a button part which is connected to the handle part and, when pressed, transmits to the server data indicating that the visit data will be sent to the wireless communication device; and one or more touchscreen touch parts which are connected to the button part and input an electrical signal to a touchscreen of the wireless communication device. The visit data may be transmitted to the wireless communication device if the button part is pressed and if the electrical signal is input to the touchscreen.

In addition, the visit data may be transmitted to the wireless communication device only when the button part is pressed within a period of time during which the electrical signal is input to the touchscreen of the wireless communication device.

### Advantageous Effects

According to the present invention, it is possible to identify whether a service user has actually visited a service providing store and then provide the service user with various benefits.

In addition, it is possible to prevent a service user from evaluating a service after falsely verifying his or her visit to a service providing store without actually visiting the service providing store.

It is also possible to reward a service user based on the accumulated number of uses not only for each service providing store but also for each individual service provider and evaluate the service of each individual service provider.

Furthermore, it is possible to provide a service user and a service provider with a new experience of accumulating mileage (points, stamps, etc.) on a coupon through a new interface.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other novel features will become apparent from the following detailed description when considered in conjunction with the drawings and the disclosed aspects are intended to include all such aspects and their equivalents.

### BRIEF DESCRIPTION OF DRAWINGS

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus a device) or method. Finally, like reference numerals denote like features throughout the specification and figures.

FIG. 1 illustrates the structure of a system for recording visit data according to an embodiment of the present invention;

FIG. 2 illustrates an aspect of recording visit data according to an embodiment of the present invention;

FIG. 3 illustrates an aspect of recording visit data according to another embodiment of the present invention;

FIG. 4 is a schematic diagram of a data transmission device according to an embodiment of the present invention;

FIG. 5 illustrates a method of recording visit data using the data transmission device of FIG. 3;

FIG. 6 is a flowchart illustrating a method of recording visit data according to an embodiment of the present invention; and

FIG. 7 illustrates visit data transmitted to an electronic device of a service user and displayed on the electronic device in a predetermined pattern.

### MODE FOR INVENTION

Various embodiments will now be described with reference to the accompanying drawings, and like reference numerals in the drawings are used to indicate like elements. While numerous specific details are set forth herein in order to provide a thorough understanding of the present invention, it will be obvious to those of ordinary skill in the art that the embodiments may be practiced without these specific details. In other instances, well-known structures and devices are presented in block diagram form in order to facilitate the description of the embodiments.

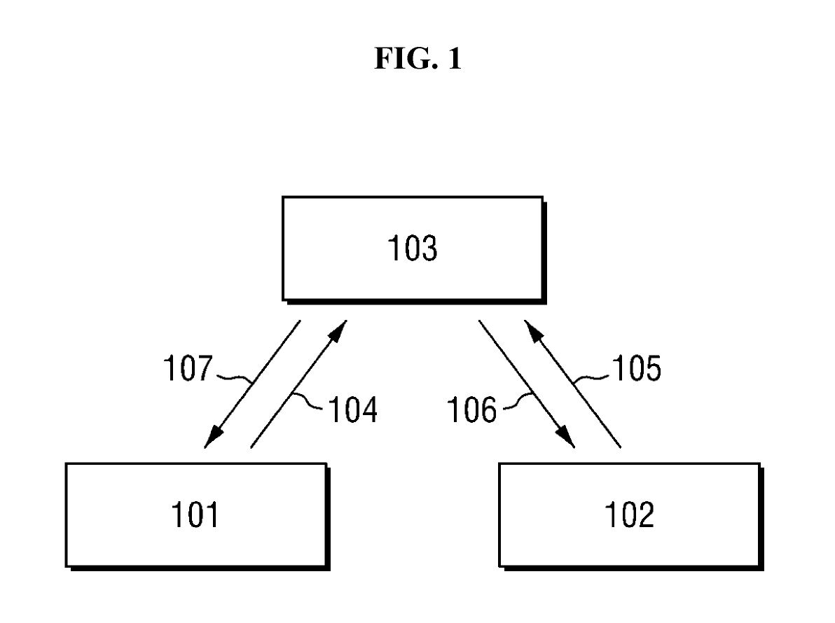

FIG. 1 illustrates the structure of a system for recording visit data according to an embodiment of the present invention.

Referring to FIG. 1, an electronic device 101 of a service provider 101, an electronic device 102 of a service user, and a server 103 may be provided.

The electronic device 101 and 102 may be, but is not limited to, a point-of-sale (POS) terminal, a smartphone, a smart pad, a computer, etc., each including a global positioning system (GPS) sensor, an acceleration sensor, and a motion recognition sensor that can respectively sense location, acceleration, and motion.

The electronic device 102 of the service user may be a wireless communication device such as a smartphone or a smart pad.

All forms of computer programs that can be connected to the server 103 may be installed in the electronic device 102. If the electronic device 102 is a smartphone or a smart pad, applications may be installed in the electronic device 102.

The server 103 may have a service provider account and a service user account.

The service provider account may be created for each service providing store or for each service provider.

The electronic device 101 of the service provider may be located in a predetermined place (e.g., a place where a service is provided). The electronic device 101 of the service provider may be, for example, a POS terminal, a computer, etc. that can be placed in a coffee shop, a hair salon, and the like. In addition, if the electronic device 101 of the service provider is a wireless communication device such as a smartphone or a smart pad, visit data may be transmitted to the electronic device 102 of the service user only when a position sensor (e.g., a GPS sensor) included in the electronic device 101 of the service provider verifies that the electronic device 101 of the service provider was located in the predetermined place.

When the electronic device 102 of the service user visits the predetermined place where the electronic device 101 of the service provider is located, the electronic device 101 of the service provider may transmit data indicating that the electronic device 102 of the service user has visited the predetermined place to the server 103 as indicated by reference numeral 104, and the electronic device 102 of the service user may transmit data indicating that it has visited the predetermined place where the electronic device 101 of the service provider is located to the server 103 as indicated by reference numeral 105.

If the two data 104 and 105 match, the server 103 may transmit visit data to the electronic device 102 of the service user as indicated by reference numeral 106. In addition, the server 103 may be store the visit data of the electronic device 102 of the service user.

The visit data transmitted to the electronic device 102 of the service user may be displayed on the electronic device 102 in a predetermined pattern.

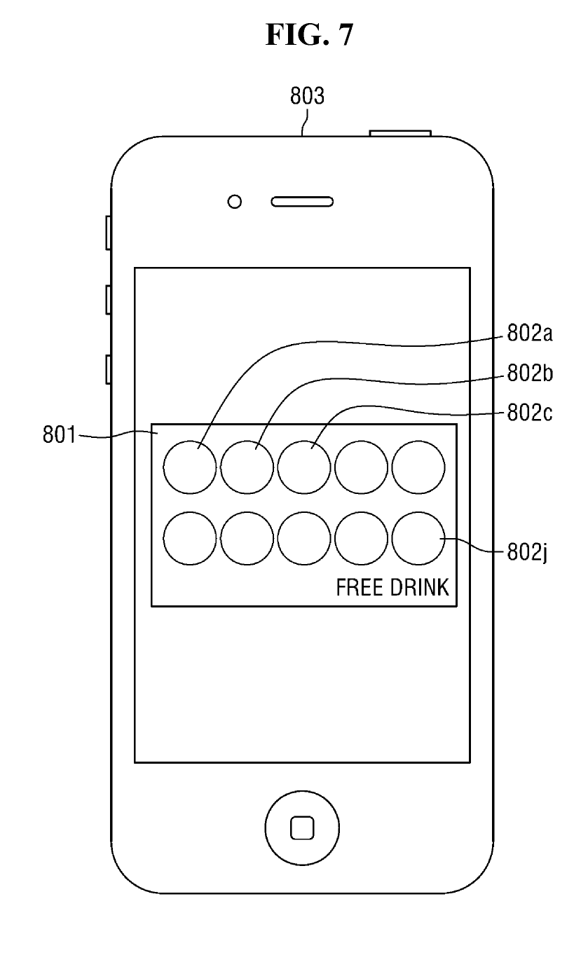

FIG. 7 illustrates visit data transmitted to an electronic device 803 of a service user and displayed on the electronic device 803 in a predetermined pattern.

Referring to FIG. 7, the electronic device 803 of the service user may be a smartphone or a smart pad, a reward coupon may be displayed on the screen of the electronic device 803 in the form of a conventional paper coupon, and visit data may be displayed in a predetermined pattern 802a, 802b, 802c, . . . ,802j according to the number of visits.

Further, referring back to FIG. 1, the electronic device 102 of the service user may transmit data about the use of a reward coupon to the server 103 as indicated by reference numeral 105, and the server 103 may transmit the data about the use of the reward coupon to the electronic device 101 of the service provider as indicated by reference numeral 107.

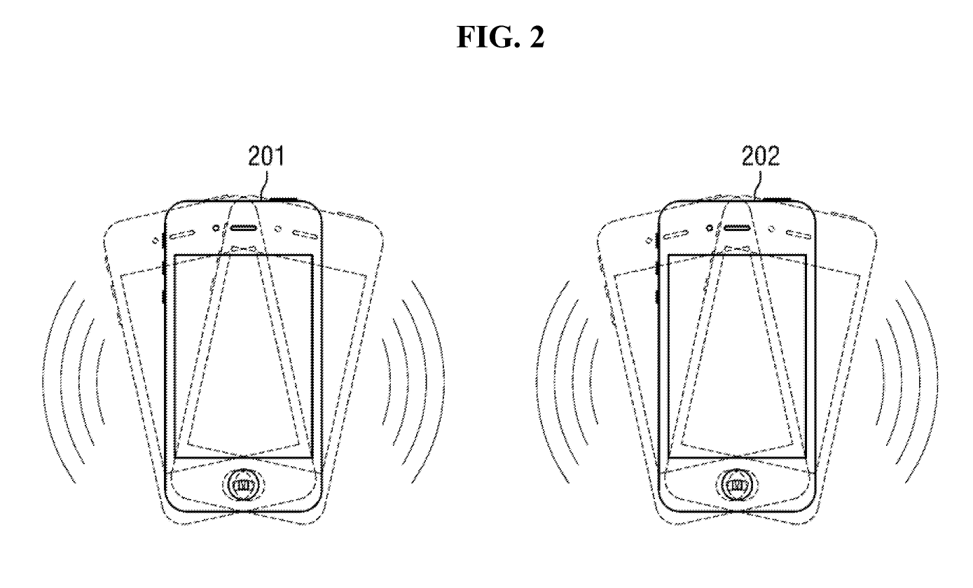

FIG. 2 illustrates an aspect of recording visit data according to an embodiment of the present invention.

Referring to FIG. 2, an electronic device according to an embodiment of the present invention may include a gyro sensor, an acceleration sensor, etc. that can detect the movement of the electronic device.

For example, BUMP TECHNOLOGIES, INC. discloses a data transmission method called “bump” in U.S. Patent Application No. 20110191823 published on Aug. 4, 2011.

According to the above invention, if two smartphones show their intentions to exchange data with each other by making a particular motion in the same place and at the same time using their position and motion sensors, data may be transmitted from a first smartphone to a server, and the data may be transmitted from the server to a second smartphone.

The present invention is based on the above invention. That is, the presence of an electronic device 202 of a service user in a service providing place where an electronic device 201 of a service provider is located should be sensed by a position sensor (e.g., a distance between the position of the electronic device 202 of the service user and the position of the electronic device 202 of the service user sensed by the position sensor should be within a predetermined range). In addition, the execution of predetermined motion conditions should be sensed (e.g., the electronic device 201 of the service provider and the electronic device 202 of the service user should be shaken from side to side), and the predetermined motion conditions should be executed within predetermined time conditions (e.g., a difference between a time when the electronic device 201 of the service provider was shaken and a time when the electronic device 202 of the service user was shaken should be less than 0.5 seconds). Only then can a server transmit visit data indicating that the electronic device 202 of the service user was located in the place where the electronic device 201 of the service provider is located to the electronic device 202 of the service user.

In FIG. 2, the electronic device 201 of the service provider is a smartphone or a smart pad. However, this is merely an example, and the electronic device 201 of the service provider is not limited to the smartphone or the smart pad. The electronic device 201 of the service provider can be any electronic device that includes a position sensor, an acceleration sensor, a gyro sensor, etc.

In addition, by identifying whether the electronic device 201 of the service provider and the electronic device 202 of the service user are located in the same place using the position sensor and then by pressing a predetermined key of each of the electronic device 201 of the service provider and the electronic device 202 of the service user, the server can be made to transmit visit data to the electronic device 202 of the service user.

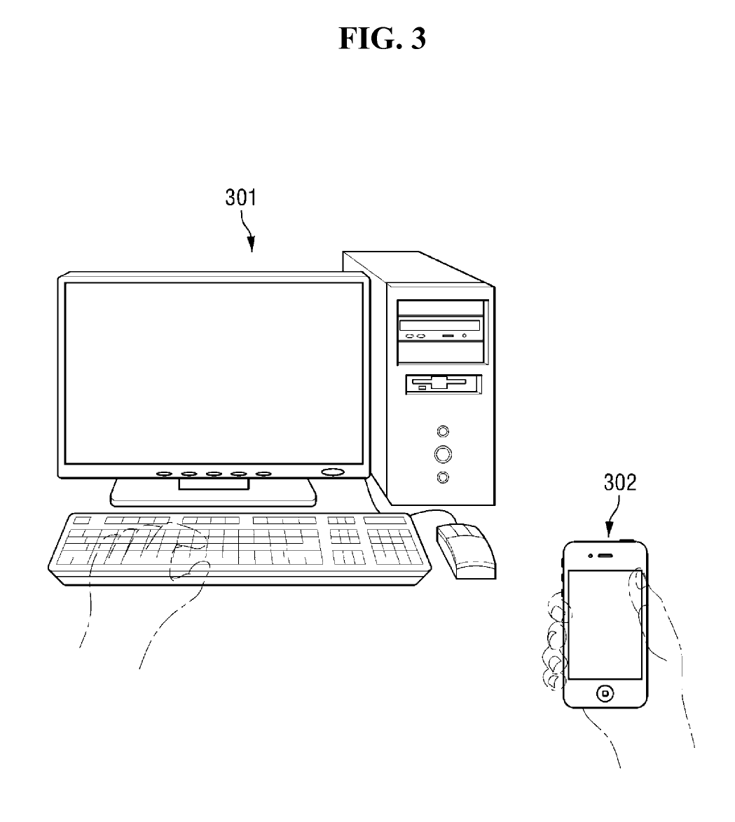

FIG. 3 illustrates an aspect of recording visit data according to another embodiment of the present invention.

Referring to FIG. 3, an electronic device 301 of a service provider may be a POS terminal, a computer, etc.

If a predetermined key (e.g., a space bar) of the electronic device 301 of the service provider is pressed and if it is sensed by position and motion sensors of an electronic device 302 of a service user that the electronic device 302 of the service user has visited a predetermined place where the electronic device 301 of the service provider is located and that a predetermined motion has been made (e.g., shaking from side to side) within a predetermined time range (e.g., a time difference of less than 0.5 seconds between a time when the predetermined key was pressed and a time when the electronic device 302 of the service user was shaken), a server may receive a signal indicating that the predetermined key has been pressed from the electronic device 301 of the service provider and a signal indicating that the predetermined motion has been made in the predetermined place from the electronic device 302 of the service user. Accordingly, the server may transmit visit data to the electronic device 302 of the service user and store the visit data.

The visit data transmitted to the electronic device 302 of the service user may be displayed on the screen of the electronic device 302 of the service user in the form of the reward coupon illustrated in FIG. 7.

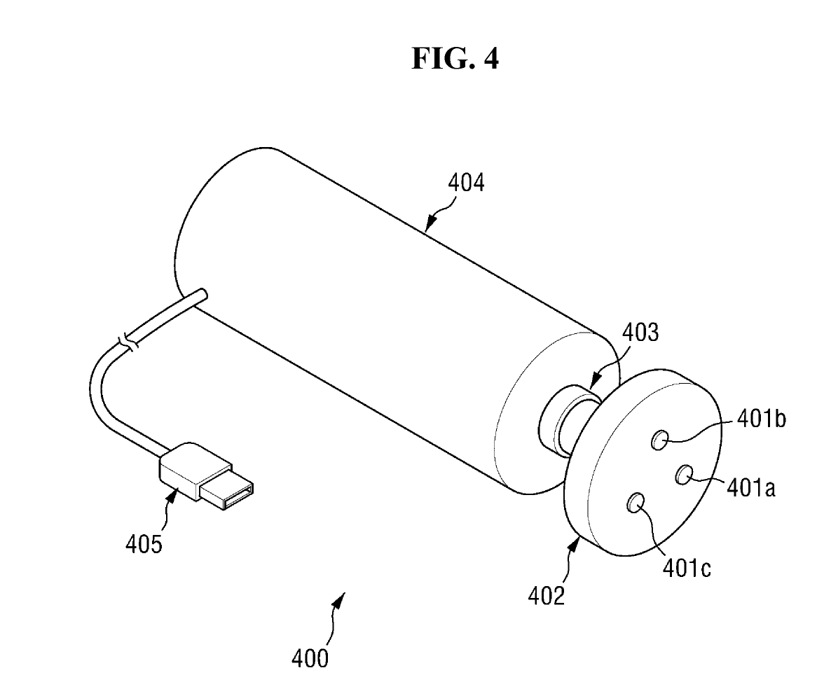

FIG. 4 is a schematic diagram of a data transmission device 400 according to an embodiment of the present invention.

Referring to FIG. 4, the data transmission device 400 which is connected to a server so as to transmit visit data to an electronic device of a service user is disclosed. The data transmission device 400 includes a handle part 404; a button part 403 which is connected to the handle part 404 and, when pressed, transmits to the server data indicating that the visit data will be sent to the electronic device of the service user; and touchscreen touch parts 401a through 401c which are connected to the button part 403 and input an electrical signal to a touchscreen of the electronic device of the service user. The visit data may be transmitted to the electronic device of the service user if the button part 403 is pressed and if an electrical signal is input to the touchscreen. The data transmission device 400 may further include a computer connector 405 needed for connection to various computers in which a computer program for transmitting visit data is installed.

The handle part 404 may be made of, for example, a conductive material. Therefore, when the handle part 404 is held by the hand, an electrical signal from the hand may be input to the touchscreen of the electronic device of the service user via the button part 403 and the touchscreen touch parts 401a through 401c.

Alternatively, the handle part 404 may not be made of a conductive material. Even in this case, when the touchscreen touch parts 401a through 401c touch the touchscreen of the electronic device of the service user, an electrical signal may be input from a computer connected to the data transmission device 400 or from the data transmission device 400 itself. Accordingly, the electrical signal may be input to the touchscreen of the electronic device of the service user.

In an example, the touchscreen touch parts 401a through 401c may be provided in the form of buttons. Therefore, when the touchscreen touch parts 401a through 401c touch the touchscreen of the electronic device of the service user, an electrical signal indicating that the buttons of the touchscreen touch parts 401a through 401c have been pressed may be input to the data transmission device 400 or a computer connected to the data transmission device 400. Accordingly, the electrical signal may be input from the computer to the touch screen of the electronic device of the service user or from the data transmission device 400 itself to the touch screen of the electronic device of the service user. According to this configuration, even if the handle part 404 is not made of a conductive material, a touch on the touch screen of the electronic device of the service user by the touch screen touch parts 401a through 401c can cause an electrical signal to be delivered to the touchscreen of the electronic device of the service user using an electric current from the data transmission device 400 or an electric current from a computer connected to the data transmission device 400. Therefore, a user can use the data transmission device 400 even while wearing gloves.

The buttons mentioned above may include buttons in both physical and electrical senses. The buttons may denote all means of physically or electrically sensing a touch on the touchscreen of the electronic device of the service user by the touchscreen touch parts 401a through 401c.

The button part 403 is configured such that the button is configured to be pressed when a user presses the touchscreen touch parts 401a through 401c against the touchscreen of the electronic device of the service user by holding the handle part 404 with the hand. If the button part 403 is pressed, the server may recognize that the electronic device of the service user has touched the touchscreen touch parts 401a through 401c. That is, if the button part 403 is pressed, it means that the service user has come to a place where the data transmission device 400 is installed and touched the data transmission device 400. Since the pressing of the button part 403 indicates that the electronic device of the service user has visited the place where the data transmission device 400 is installed, data indicating that visit data will be sent to the electronic device of the service user may be received.

In an example, the touch screen touch parts 401a through 401c may be made of a conductive material. In the current embodiment, the number of the touch screen touch parts 401a through 401c is three. However, this is merely an example, and the number of the touch screen touch parts 401a through 401c can also be one or greater.

The touchscreen touch parts 401a through 401c may be surrounded by a protective part 402 which is made of a nonconductive material that does not damage the touchscreen.

When the touchscreen of the electronic device of the service user is touched by the touchscreen touch parts 401a through 401c, data indicating that the electronic device of the service user has visited the place where the data transmission device 400 is installed may be transmitted to the server. When the button part 403 is pressed and when an electrical signal is input to the touchscreen, visit data may be transmitted from the server to the electronic device of the service user.

In addition, the visit data may be transmitted to the wireless communication device (i.e., the electronic device of the service user) only when the button part 403 is pressed within a period of time during which an electrical signal is input to the touchscreen of the wireless communication device.

The visit data transmitted to the electronic device of the service user may be displayed on the screen of the electronic device of the service user in the form of the reward coupon illustrated in FIG. 7.

While a case where the button part 403 of the data transmission device 400 is pressed has been described above as a condition for transmitting visit data, this is merely an example. That is, the data transmission device 400 may include a motion sensor, a gyro sensor and an acceleration sensor, and a case where the movement of the data transmission device 400 is sensed by the above sensors can be set as a condition for transmitting visit data.

In addition, a case where the touchscreen of the electronic device of the service user is touched by the touchscreen touch parts 401a through 401c has been described above as a condition for transmitting to the server data indicating that the electronic device of the service user has visited the place where the data transmission device 400 is installed. However, this is merely an example. That is, an electrical signal may not be input from the touchscreen touch parts 401a through 401c. Instead, the touchscreen touch parts 401a through 401c may physically press the touchscreen of the electronic device of the service user, thereby moving the electronic device of the service user. This movement of the electronic device of the service user may be sensed by sensors included in the electronic device of the service user. Accordingly, data indicating that the electronic device of the service user has visited the place where the data transmission device 400 is installed may be transmitted to the server.

In an embodiment, the electronic device of the service user may be placed on a support made of an elastic material. When the data transmission device 400 presses the electronic device of the service user placed on the support using the touchscreen touch parts 401a through 401c, the data transmission device 400 and the electronic device of the service user may be moved by the elasticity of the support. This movement may be sensed, and thus data indicating that the electronic device of the service user has visited the place where the data transmission device 400 is installed may be transmitted to the server.

In addition, whether the data transmission device 400 and the electronic device of the service user are located in the same place may be sensed based on the position of a computer (such as a POS terminal or a main computer) connected to the data transmission device 400 and a position sensed by a position sensor (e.g., a GPS sensor) included in the electronic device of the service user or based on a position sensed by a position sensor included in the data transmission device 400 and a position sensed by the position sensor included in the electronic device of the service user.

In addition, according to another embodiment of the present invention, the data transmission device 400 may include a button part which transmits to the server data indicating that visit data will be sent to the wireless communication device when pressed; and one or more touchscreen touch parts which are connected to the button part and designed to touch the touchscreen of the wireless communication device. The wireless communication device may transmit data indicating that it was located in the place where the data transmission device 400 is installed based on a position sensor and a motion sensor. For example, the wireless communication device may be placed on a support having elasticity. When the touchscreen touch parts of the data transmission device 400 touch the touchscreen of the wireless communication device, the button part of the data transmission device 400 may be pressed, causing the wireless communication device and the support to be pressed. This movement of the wireless communication device and the support may be sensed by the motion sensor. Accordingly, the wireless communication device may transmit to the server data indicating that the touchscreen thereof has been touched by the touchscreen touch parts, and the server may transmit visit data to the wireless communication device.

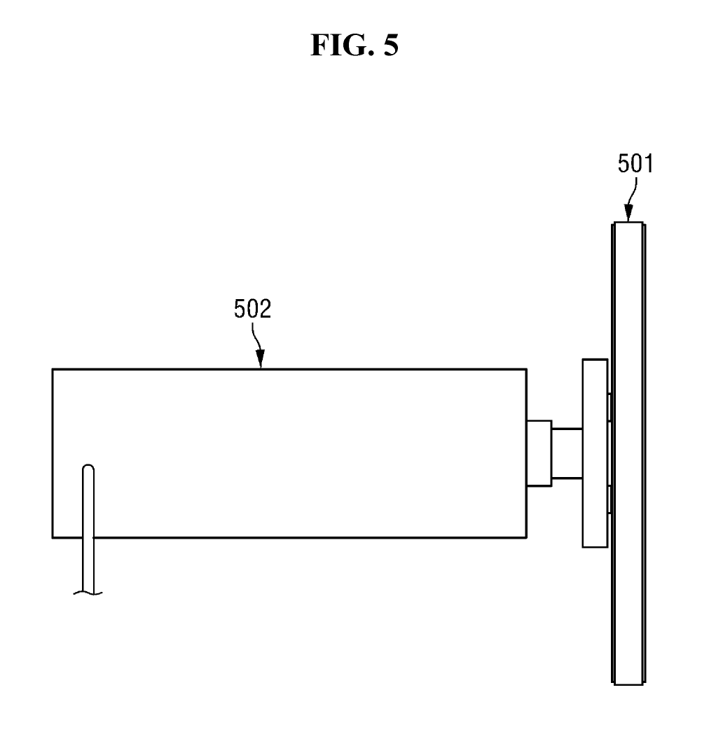

FIG. 5 illustrates a method of recording visit data using the data transmission device of FIG. 3.

Referring to FIG. 5, one or more touchscreen touch parts of a data transmission device 502 may be made to touch an electronic device 501 of a service user, so that visit data can be input to the electronic device 501 of the service user in the form of the reward coupon illustrated in FIG. 7.

For example, stamps may be accumulated on a reward coupon through an interface that allows the data transmission device 502 shaped like a stamp to stamp the reward coupon displayed on the touchscreen of the electronic device 501 of the service user. This can provide a new user experience, causing a service user and a service provider to have the fun of accumulating stamps on the reward coupon.

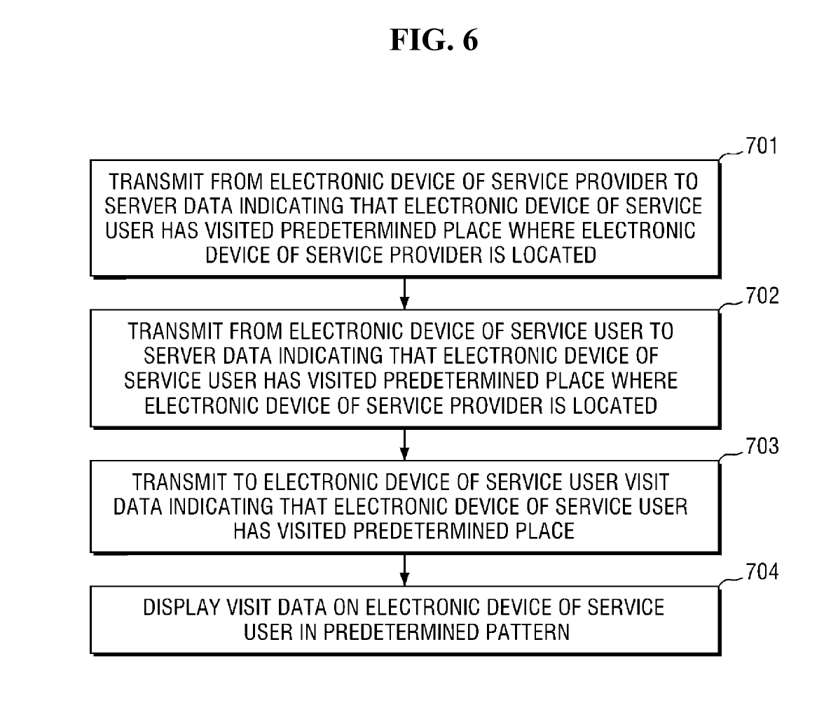

FIG. 6 is a flowchart illustrating a method of recording visit data according to an embodiment of the present invention.

Referring to FIG. 6, in the method of recording visit data of a wireless communication device, data indicating that an electronic device of a service user has visited a predetermined place where an electronic device of a service provider is located may be transmitted from the electronic device of the service provider to a server (operation 701). Then, data indicating that the electronic device of the service user has visited the place where the electronic device of the service provider is located may be transmitted from the electronic device of the service user to the server (operation 702). Next, visit data indicating that the electronic device of the service user has visited the predetermined place may be transmitted to the electronic device of the service user (operation 703). Finally, the visit data may be displayed on the electronic device of the service user in a predetermined pattern (operation 704).

For example, a service provider account and a service user account may be created on an application. For example, a service provider may include the concept of a service providing store. Therefore, when a service provider account is created, the name, service type, service category, location and representative of a service providing store, information about each individual service provider, etc, may be input. For example, the service provider account may be set for each store such as a restaurant, a coffee shop, a hair salon or a nail salon or for each individual service provider such as a table manager of a restaurant, a barista of a coffee shop, a hair stylist of a hair salon or a nailist of a nail salon.

A service user account can be created in various ways. A service user can create a service user account by formally inputting his or her personal information (such as name, resident registration number, and mail address) to a homepage or an application of a smartphone (such as a tablet PC). Alternatively, the service user can create the service user account even without his or her personal information by using various methods, for example, by installing an application in a smartphone or by visiting a store. In this case, the service user may use a unique number or unique ID (e.g., UDID of iPhone of Apple Computer Inc.) of his or her smartphone. The service user account thus created may be stored in the smartphone and authenticated by a service providing store.

Visit data indicating that a service user has visited a service provider may be accumulated for each service providing store or for each individual service provider. That is, visit data indicating that a service user has visited a service providing store such as a cafe can be accumulated, or visit data indicating that the service user has visited a service provider such as a particular barista can be accumulated. To accumulate visit data indicating that a service user has visited a service provider such as a particular barista, the visit data may be transmitted to an electronic device of the service user using a smartphone logged into an account of the particular barista or may be transmitted to the electronic device of the service user by a data transmission device designated for the account of the particular barista.

Visit data may be accumulated in a server. This data may not only be displayed on an electronic device of a service user in the form of a reward coupon but also be accumulated in the server in the form of information including, but not limited to, the number of visits by the service user, the location of a visited store, order contents, and order amounts. This data may also be data about the use of a service offered by a service providing store or data about the user of a service offered by a service provider. For example, when a service user gets a haircut by service provider A and a perm by service provider B at a hair salon, the contents of the service may be stored for the service providing store as haircut data and perm data. Alternatively, the haircut data may be stored for service provider A, and the perm data may be stored for service provider B. Such data can be retrieved from the server at any time by both a service provider and a service user.

A service user may be rewarded based on accumulated data.

For example, when data shows that the accumulated number of visits by a service user is ten times, one free coupon may be issued to the service user. The contents of the reward may include, but not limited to, accumulating mileage, offering accumulated money, and providing a product. In addition, the contents of the reward can be retrieved from the server at any time by both a service provider and a service user.

In addition, a reward may be provided to the service user by a service providing store or by an individual service provider. That is, one free haircut service may be provided based on ten visits to a service providing store such as a hair salon or based on ten visits to a service provider such as a particular hair stylist. Since the service user can be rewarded for the accumulated use of each individual service provider, even if a particular service provider moves to a different store, benefits for the service user can be continuously accumulated as long as the service user receives the particular service provider's service.

The evaluation of a service providing store or an individual service provider may be input to the server by the service user.

The contents of the evaluation may be shared with other service users through a social network service (SNS) such as Facebook or within an application. Alternatively, only the representative of a service providing store may be allowed to view the evaluation of each individual service provider. Accordingly, the representative of the service providing store can reward or punish each individual service provider based on the evaluation of the individual service provider.

In addition, of participants in an actual offline meeting, only those who received visit data through their electronic devices may be surveyed or entitled to cast a vote.

According to an embodiment of the present invention, a system for recording visit data of a wireless communication device may be disclosed. The system may include the wireless communication device which includes one or more sensors that can recognize locations and motions; an electronic device which includes one or more keys for transmitting data to a server; and the server which transmits to the wireless communication device visit data indicating that the wireless communication device has visited a location where the electronic device is installed. If the presence of the wireless communication device in the location where the electronic device is installed is sensed by the sensors included in the wireless communication device, if a predetermined key among the keys of the electronic device is pressed, and if a predetermined motion of the wireless communication device is sensed by the sensors included in the wireless communication device, the server may transmit visit data indicating that the wireless communication device has visited the location where the electronic device is installed to the wireless communication device.

For example, the predetermined key among the keys of the electronic device may be a space bar, and the predetermined motion of the wireless communication device may be to shake the wireless communication device once from side to side.

In addition, the visit data may be transmitted only when a difference between a time when the predetermined key among the keys of the electronic device is pressed and a time when the predetermined motion of the wireless communication device is sensed is within a predetermined condition.

For example, the visit data may be transmitted only when the difference between the time when the predetermined key among the keys of the electronic device is pressed and the time when the predetermined motion of the wireless communication device is sensed is less than five seconds.

For example, the visit data may be transmitted only when a distance from a location where the electronic device is known to be installed to a location where the presence of the wireless communication device in the location of the electronic device is sensed by the sensors included in the wireless communication device, that is, a location sensed by a position sensor of the wireless communication device is within a predetermined condition.

For example, the visit data may be transmitted only when the distance from the location where the electronic device is known to be installed to the location sensed by the position sensor of the wireless communication device is less than five meters.

The location where the electronic device is known to be installed may be sensed by a position sensor included in the electronic device or may be identified from the position of an affiliated store, a service provider, etc. where the electronic device is reported to be installed.

According to another embodiment of the present invention, a system for recording visit data of a wireless communication device may be disclosed. The system may include the wireless communication device which includes one or more keys for transmitting data to a server; an electronic device which includes one or more keys for transmitting data to the server; and the server which transmits to the wireless communication device visit data indicating that the wireless communication device has visited a location where the electronic device is installed. If the presence of the wireless communication device in the location where the electronic device is installed is sensed by the sensors included in the wireless communication device, if a predetermined key among the keys of the electronic device is pressed, and if a predetermined key among the keys of the wireless communication device is pressed, the server may transmit data indicating that the wireless communication device has visited the location where the electronic device is installed to the wireless communication device.

For example, the predetermined key among the keys of the wireless communication device may be a button displayed on a display such as a touchscreen) in a state where an application installed in the wireless communication device is executed, and the predetermined key among the keys of the electronic device may be a space bar.

In addition, the visit data may be transmitted only when a difference between a time when the predetermined key among the keys of the electronic device is pressed and a time when the predetermined key among the keys of the wireless communication device is pressed is within a predetermined condition.

For example, the visit data may be transmitted only when the difference between the time when the predetermined key among the keys of the electronic device is pressed and the time when the predetermined key among the keys of the wireless communication device is pressed is less than five seconds.

For example, the visit data may be transmitted only when a distance from a location where the electronic device is known to be installed to a location where the presence of the wireless communication device in the location of the electronic device is sensed by the sensors included in the wireless communication device, that is, a location sensed by a position sensor of the wireless communication device is within a predetermined condition.

For example, the visit data may be transmitted only when the distance from the location where the electronic device is known to be installed to the location sensed by the position sensor of the wireless communication device is less than five meters.

The location where the electronic device is known to be installed may be sensed by a position sensor included in the electronic device or may be identified from the position of an affiliated store, a service provider, etc. where the electronic device is reported to be installed.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage media may be any available media that can be accessed by a general-purpose computer or a special computer. By way of example, and not limitation, such computer-readable media can comprise random access memory (RAM), read only memory (ROM), electrically erasable programmable ROM (EEPROM), CD-ROM or other optical disk storage, magnetic disk storage or other magnetic storage devices, or any other medium that can be used to carry or store desired program code in the form of instructions or data structures and that can be accessed by a general-purpose computer, a special computer, a general-purpose processor or a special processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition, data communication between a server and a terminal may be executed through all short-distance and long-distance communication means.

The description of the disclosed exemplary embodiments is provided to enable any person skilled in the art to make or use the invention. Various modifications to these exemplary embodiments will be readily apparent to those skilled in the art, and the generic principles defined herein may be applied to other embodiments without departing from the spirit or scope of the invention. Thus, the invention is not intended to be limited to the exemplary embodiments shown herein but is to be accorded the widest scope consistent with the principles and novel features disclosed herein.

1. A system for recording visit data of a wireless communication device, the system comprising:
an electronic device which comprises one or more sensors that can recognize locations and motions;
the wireless communication device which comprises one or more sensors that can recognize locations and motions; and
a server which transmits to the wireless communication device data indicating that the wireless communication device has visited a location where the electronic device is installed if it is sensed by the sensors of the electronic device and the sensors of the wireless communication device that the electronic device and the wireless communication device exist within a predetermined distance range and that predetermined motion conditions have been executed.

2. A method of recording visit data of a wireless communication device, the method comprising:
transmitting data indicating that the wireless communication device has visited a predetermined place where an electronic device is installed from the electronic device to a server;
transmitting data indicating that the wireless communication device has visited the predetermined place where the electronic device is installed from the wireless communication device to the server; and
transmitting visit data indicating that the wireless communication device has visited the predetermined place to the wireless communication device.

3. The method of claim 2, further comprising displaying the visit data on the wireless communication device in a predetermined pattern.

4. A system for recording visit data of a wireless communication device, the system comprising:
the wireless communication device which comprises one or more sensors that can recognize locations and motions;
an electronic device which comprises one or more keys for transmitting data to a server; and
the server which transmits to the wireless communication device visit data indicating that the wireless communication device has visited a location where the electronic device is installed,
wherein the server transmits to the wireless communication device the visit data indicating that the wireless communication device has visited the location where the electronic device is installed if a predetermined key among the keys of the electronic device is pressed and if a predetermined motion of the wireless communication device is sensed by the sensors included in the wireless communication device.

5. A system for recording visit data of a wireless communication device, the system comprising:
the wireless communication device which comprises one or more keys for transmitting data to a server;
an electronic device which comprises one or more keys for transmitting data to the server; and
the server which transmits to the wireless communication device visit data indicating that the wireless communication device has visited a location where the electronic device is installed,
wherein the server transmits to the wireless communication device the visit data indicating that the wireless communication device has visited the location where the electronic device is installed if the presence of the wireless communication device in the location where the electronic device is installed is sensed by a position sensor of the wireless communication device, if a predetermined key among the keys of the electronic device is pressed, and if a predetermined key among the keys of the wireless communication device is pressed.
